(19) United States
(12) Patent Application Publication
(10) Pub. No.: US 2006/0237948 A1
(43) Pub. Date: Oct. 26, 2006

(54) Frame folding apparatus of a baby stroller

(75) Inventors: Youn-Fu You, Changhua City (TW); Wei-Yeh Li, Tainan County (TW); Ying-jen Chen, Taichung City (TW)

Correspondence Address: BIRCH STEWART KOLASCH & BIRCH, PO BOX 747, FALLS CHURCH, VA, 22040-0747, US

(73) Assignee: Link Treasure Limited

(21) Appl. No.: 11/267,270

(22) Filed: Nov. 7, 2005

(30) Foreign Application Priority Data
Apr. 21, 2005 (TW) 094206283

(51) Int. Cl. B62B 7/06

(52) U.S. Cl. 280/642

(57) ABSTRACT

The invention discloses a frame folding apparatus of a baby stroller that includes a frame capable of being folded longitudinally and transversally and a rear support frame of the frame pivotally connected to a transversal support frame, and an end of said transversal support frame is connected to a sliding cover, and the sliding cover slides on the rear support frame, and a fixing member latches and fixes a sliding cover on the rear support frame, such that the transversal support frame can spread open and fix the frame. A release device is installed at an appropriate position of the frame for controlling the movement of the fixing member to separate the latch of the sliding cover, and the transversal support frame drives the frame to be folded transversally.

### FIELD OF THE INVENTION

The present invention relates to a frame folding apparatus of a baby stroller that includes a transversal support frame pivotally coupled to a rear support frame of the baby stroller, an end of the transversal support frame is movable along the rear support frame and the other end of the transversal support frame is fixed to the rear support frame by a fixing member, so that the frame can be spread open and fixed by the transversal support frame for the use of the stroller.

### BACKGROUND OF THE INVENTION

A baby stroller is a transportation means for carrying an infant. The traditional baby stroller usually comes with a folding structure for reducing the storing or carrying volume of the baby stroller

There are various designs of traditional folding baby strollers which can be mainly divided into a cloth stroller and a canopy stroller according to the folding design. As implied by its name, the canopy stroller uses a pair of lower cross pipes and a pair of rear cross pipes to construct the frame of the stroller, and the lateral frame serves as a folding apparatus similar to a canopy, so as to reduce the volume of carrying or storing the stroller. Since a general baby stroller uses a folding module disposed at the lower section of the frame for controlling the folding of the canopy stroller. A general folding module mainly includes a pair of iron plates and a lock, so that when the frame is spread open, the folding module uses the lock to secure the iron plate, so that the support frame is spread open and fixed in a position. If it is necessary to fold the stroller, a user has to use his or her leg to prop the folding module, and thus the frame is in a folding status. The user further pushes the handle pipe to fold the frame. However, such folding process is very inconvenient, and also may damage the surface of the user's shoes.

### SUMMARY OF THE INVENTION

Therefore, it is a primary objective of the present invention to overcome the shortcomings of the foregoing prior art baby stroller that cannot be folded conveniently and may damage the user's shoe during its operation. The invention provides a frame folding apparatus of a baby stroller that comprises a canopy stroller frame, wherein a transversal support frame is pivotally coupled to a rear support frame disposed at the back of the frame, and one end of the transversal support frame is connected to a sliding cover, and the sliding cover can slide on the rear support frame, and the sliding cover is fixed to the rear support frame by a fixing member, so that the transversal support frame can spread open and fix the frame in a using status. In addition, the invention further comprises a release device installed at an appropriate position of the frame for controlling the movements of the fixing member to release the sliding cover, and thus the transversal support frame can further drives the frame to be folded transversally.

Other objectives and advantages of the present invention will become apparent in the following detailed description of the preferred embodiments with reference to the accompanying drawings. However, only some embodiments of the present invention have been illustrated in the drawings, but it should be pointed out that numerous modifications and variations could be made thereto by those skilled in the art without departing from the scope and spirit of the invention set forth in the claims.

### BRIEF DESCRIPTION OF THE DRAWINGS

FIG. 1 is a schematic view of a frame of the invention;

FIG. 2 is an exploded view of a release device of the invention;

FIG. 3 is a cross-sectional view of the movements of the invention;

FIG. 4 is a schematic view of folding the rear side of the invention;

FIG. 5 is a schematic view of folding a stroller of the invention;

FIG. 6 is a schematic view of a folded stroller of the invention;

FIG. 7 is a side view of a pulling hook being installed at the pushing rod according to the invention;

FIG. 8 is a cross-sectional view of a press button being used as the release device according to the invention; and

FIGS. 9A and 9B are schematic and cross-sectional views of a pulling member used as a release device according to the invention.

### DETAILED DESCRIPTION OF THE PREFERRED EMBODIMENTS

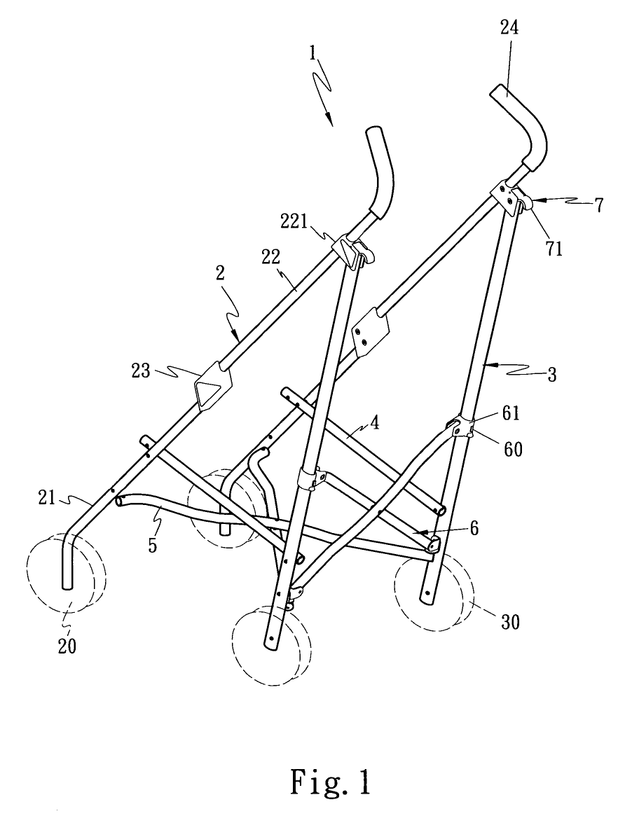

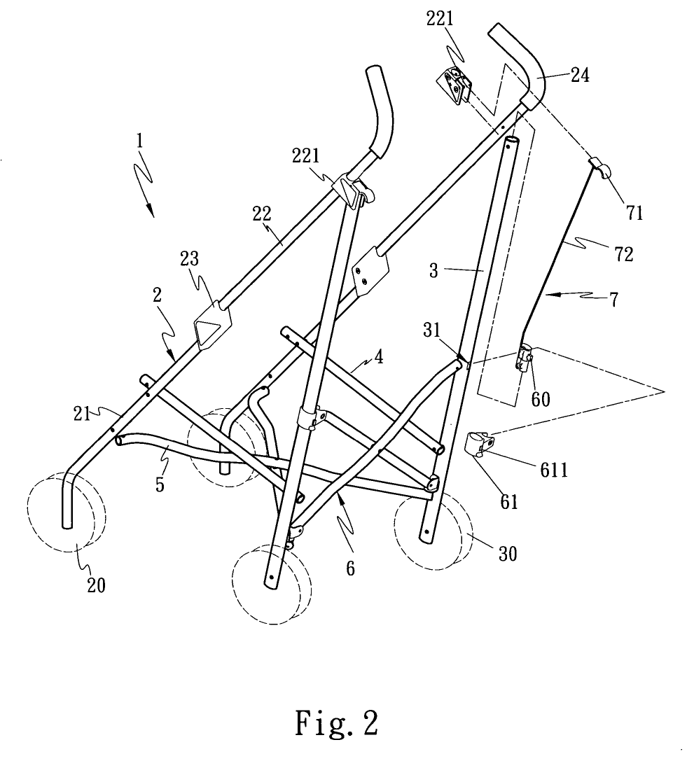

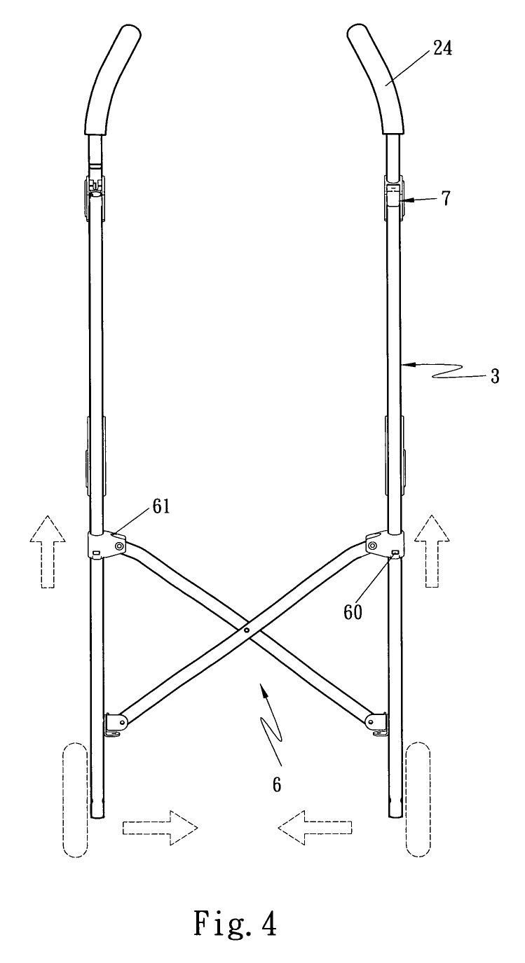

Referring to FIGS. 1, 2, 3A, 3B and 4, a frame folding apparatus of a baby stroller in accordance with a preferred embodiment of the invention provides a convenient way for users to fix a frame 1 of the baby stroller after the frame is folded or spread open longitudinally and transversally. The frame folding apparatus of the baby stroller of the invention comprises a front support frame 2, a rear support frame 3, a link rod 4, a cross pipe 5 and a transversal support frame 6.

The front support frame 2 comprises a front leg rod 21 and a pushing rod 22. The lower end of the front leg rod 21 is connected to a front wheel 20, and the upper end of the front leg rod 21 is pivotally connected to the lower end of a pulling rod 22 that has a handle 24 by a pivotal joint 23, such that the pushing rod 22 and the front leg rod 21 are turned and drawn close to each other when the frame 1 is folded.

The rear support frame 3 has its lower end connected to a rear wheel 30 and its upper end pivotally connected to a pivotal connecting base 221 that is fixed onto both sides of the pushing rod 22, such that the rear support frame 3 can be drawn close to the front support frame 2.

The link rod 4 is pivotally connected between both sides of the front support frame 2 and a rear support frame 3 for driving the front support frame 2 and the rear support frame 3 to be drawn close to each other when the frame 1 is spread open or folded.

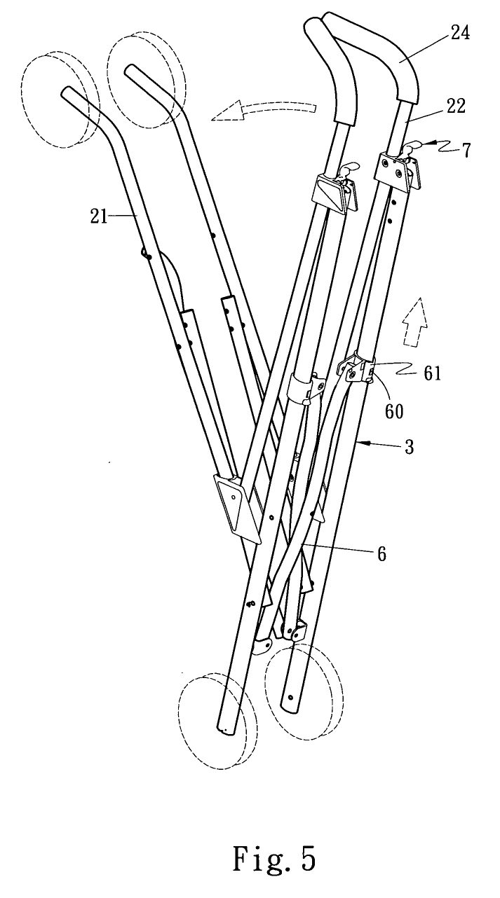

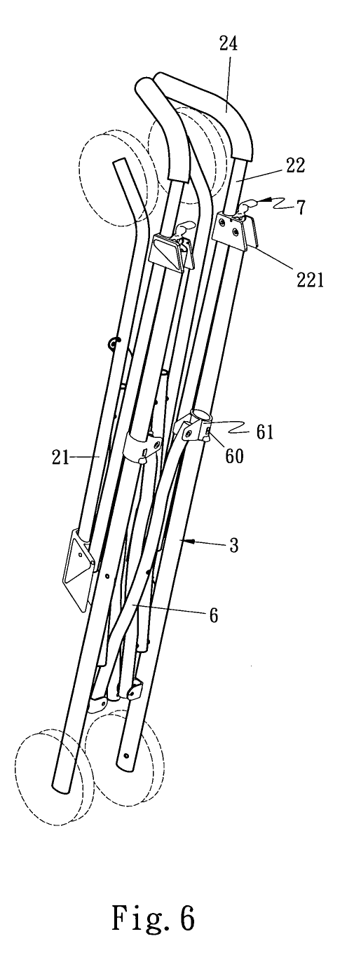

The cross pipe 5 is pivotally connected to the front support frame 2 and the lower side of the rear support frame 3 in a cross manner, so that when both sides of the transversal support frame 6 and the frame 1 are folded, both sides of the frame 1 are drawn close to the middle transversally as shown in FIGS. 5 and 6.

The transversal support frame 6 is pivotally connected between both sides of the rear support frame 3 in a cross manner for transversally supporting both sides of the frame 1, wherein the upper end of the transversal support frame 6 is pivotally connected to a sliding cover 61 that can be moved along the rear support frame 3. In this preferred embodiment, the sliding cover 61 includes a fixing hole 611, and the fixing hole 611 can be latched to a fixing member 60 that is installed in the rear support frame 3 and can be moved, so that after the transversal support frame 6 is spread open, the transversal support frame 6 can be fixed and further both sides of the frame 1 can be spread open transversally to fix the stroller for its use.

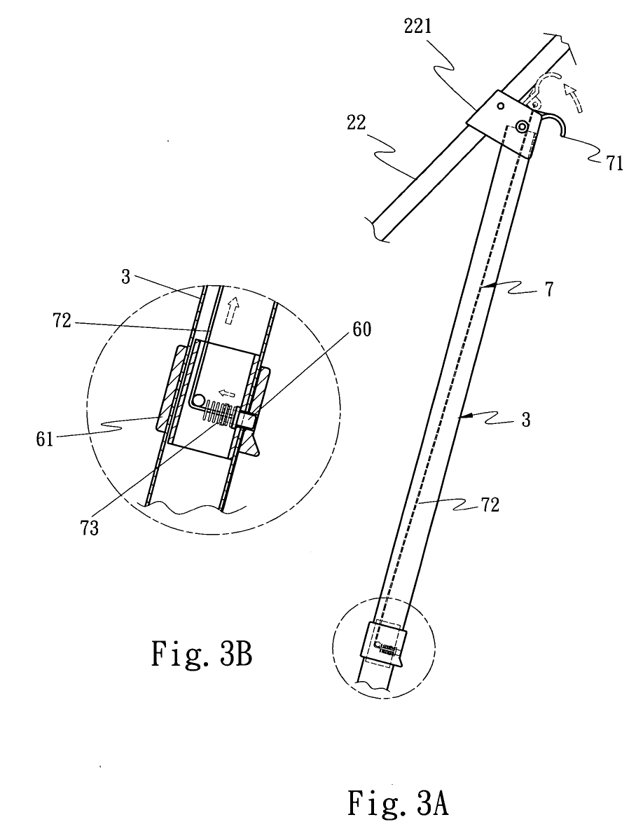

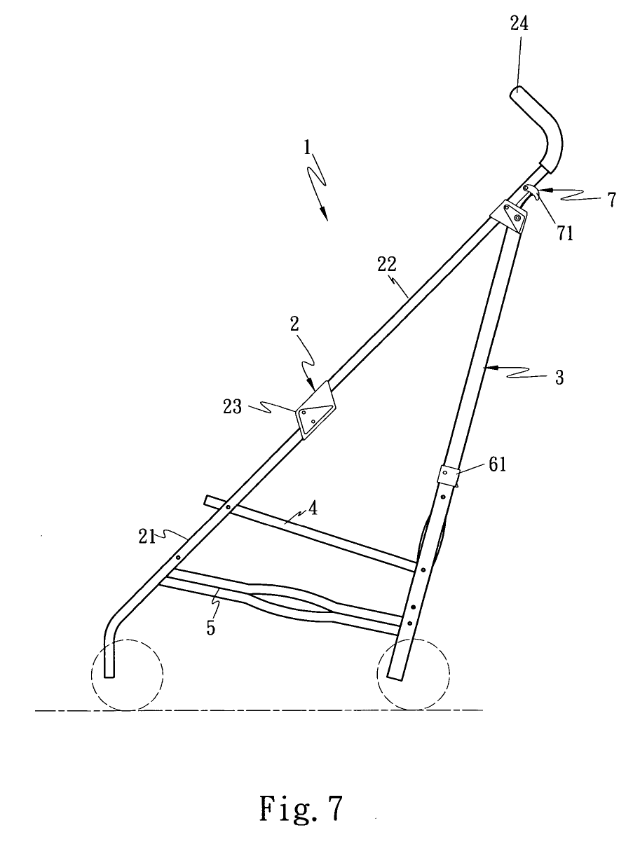

The release device 7 in accordance with this preferred embodiment is installed at an appropriate position of the frame 1 to facilitate the user's operation of the stroller. In FIG. 7, a pair of pulling hooks 71 are installed at the upper end of the rear support frame 3 or on the pushing rod 22, and a link member 72 pulls a fixing member 60, so that the fixing member 60 remains latched by means of the resilient member 73 as shown in FIG. 3B. The pulling of the link member 72 releases the sliding cover 61, and thus the frame 1 is in a folding status. The user can push the pushing rod 22 longitudinally towards the front leg rod 21, so that the sliding cover 61 can be slid on the rear support frame 3, and the transversal support frame 6 transversally draws both sides of the rear support frame 3 towards the middle to fold the stroller.

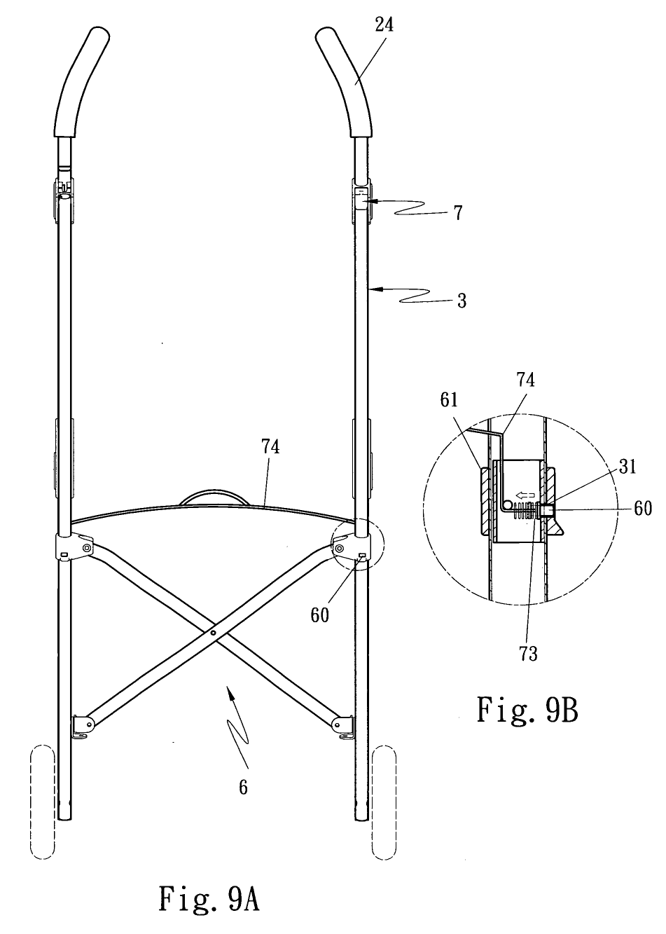

Referring to FIGS. 9A and 9B for this preferred embodiment, the release device 7 is a pulling member 74 transversally coupled between both sides of the fixing member 60, and the pulling member 74 is pulled simultaneously to move the fixing member 60 to release the rear support frame 3 from the fixing member 60, so that the frame 1 is in a folding status.

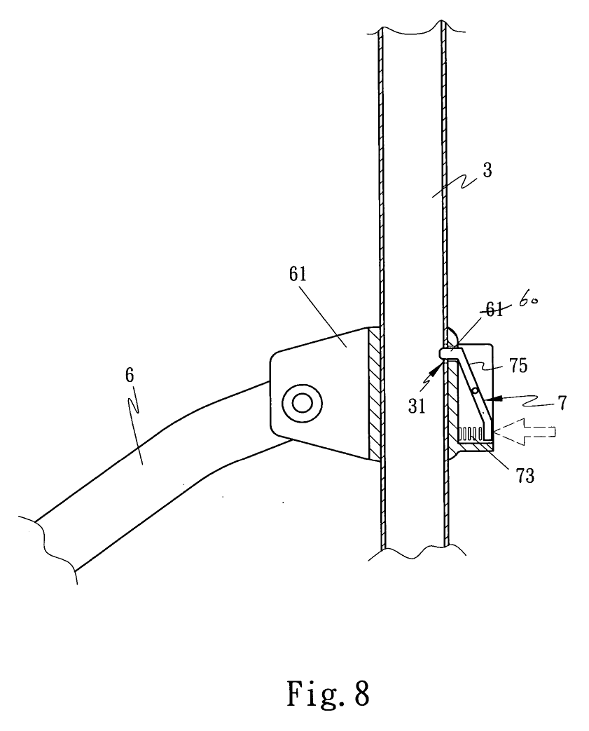

Referring to FIG. 8 for another kind of release device 7, the release device 7 installs a press button 75 on the sliding cover 61, and a fixing member 60 is extended from an end of the press button 75, so that the fixing member 60 remains latched with a latch hole 31 of the rear support frame 3 by means of a resilient member 73, and the frame 1 is spread open and fixed. The user can press the press button 75 directly, and thus the fixing member 60 can be separated from the latch hole 31, and the frame 1 is in a folding status.

While the invention has been described by means of specific embodiments, numerous modifications and variations could be made thereto by those skilled in the art without departing from the scope and spirit of the invention set forth in the claims.

What is claimed is:

1. A frame folding apparatus of a baby stroller, for spreading open and fixing said baby stroller frame and folding said baby stroller frame transversally and longitudinally, said frame folding apparatus comprising:
a frame, comprising a front support frame, a rear support frame, a pair of link rods, and a transversal support frame, wherein two ends of said pair of link rods are pivotally and respectively coupled between said front support frame and said rear support frame, and said transversal support frame is pivotally coupled onto said rear support frame, and an end of said transversal support frame is slid along said rear support frame and latched with said rear support frame at a fixed position by a fixing member, such that said transversal support frame transversally spreads open and fixes said frame, and said frame is in a spread open status; and
a release device, installed onto said frame for releasing the latch of said fixing member and said transversal support frame, so that said frame is folded and in a folding status.

2. The frame folding apparatus of a baby stroller of claim 1, wherein said frame further comprises a pair of cross pipes, and two ends of said pair of cross pipes are pivotally and respectively coupled between said front support frame and the lower side of said rear support frame to assist said frame to complete the processes of transversally spreading open or folding said baby stroller.

3. The frame folding apparatus of a baby stroller of claim 1, wherein said transversal support frame has an end pivotally coupled to a sliding cover, and said sliding cover is moved on said rear support frame and latched with said fixing member, and said transversal support frame transversally spreads open and fixes said frame.

4. The frame folding apparatus of a baby stroller of claim 3, wherein said sliding cover further comprises a fixing hole for fixing said fixing member.

5. The frame folding apparatus of a baby stroller of claim 3, wherein said fixing member uses a resilient member to keep said sliding cover to be latched.

6. The frame folding apparatus of a baby stroller of claim 1, wherein said release device comprises a pair of pulling hooks and a link member, wherein said link member is coupled between said fixing member and said pulling hook, and said pulling hook is moved and said link member is transmitted to move said fixing member and release said sliding cover, and said frame is in a folding status.

7. The frame folding apparatus of a baby stroller of claim 6, wherein said pulling hook is installed at an upper end of said rear support frame.

8. The frame folding apparatus of a baby stroller of claim 6, wherein said front support frame comprises a pushing rod, and said pulling hook is installed onto said pushing rod.

9. The frame folding apparatus of a baby stroller of claim 1, wherein said fixing members are disposed separately on both sides of said frame, and said release device includes a pulling member transversally coupled between said fixing members, and said pulling member simultaneously pulls said fixing members on both sides of said frame to release said rear support frame from said fixing member, so that said frame in a folding status.

10. The frame folding apparatus of a baby stroller of claim 3, wherein said sliding cover installs a press button, and a fixing member is extended from an end of said press button, and a resilient member keeps said fixing member latched and fixed with said rear support frame, and said frame is fixed after said frame is spread open.
